(19) United States
(12) Patent Application Publication
(10) Pub. No.: US 2014/0241499 A1
(43) Pub. Date: Aug. 28, 2014

(54) RADIATION IMAGING APPARATUS, CONTROL METHOD THEREFOR, AND NON-TRANSITORY COMPUTER-READABLE STORAGE MEDIUM

(71) Applicant: CANON KABUSHIKI KAISHA, Tokyo (JP)

(72) Inventor: Keiji Tsuchiya, Kawasaki-shi (JP)

(73) Assignee: CANON KABUSHIKI KAISHA, Tokyo (JP)

(21) Appl. No.: 14/160,815

(22) Filed: Jan. 22, 2014

(30) Foreign Application Priority Data
Feb. 22, 2013 (JP) 2013-033868

(51) Int. Cl. G01N 23/04

(52) U.S. Cl. CPC G01N 23/04
USPC 378/62

(57) ABSTRACT

A radiation imaging apparatus includes a radiation generation unit configured to generate radiation and a plurality of detection units each configured to detect the radiation irradiated from the radiation generation unit, and acquires an image based on the radiation detected by one of the plurality of detection units. The radiation imaging apparatus accepts a radiation irradiation instruction, and adjusts a time of generating radiation by the radiation generation unit so that a length of a time period from when the irradiation instruction is accepted until radiation irradiation is performed becomes constant, based on time duration, each of the plurality of detection units, from when the irradiation instruction is accepted until the detection unit enters a radiation detectable state.

### BACKGROUND OF THE INVENTION

1. Field of the Invention

The present invention relates to a radiation imaging technique.

2. Description of the Related Art

In recent years, there has been proposed a method of performing imaging using one of a plurality of different types of detectors of an X-ray imaging system (International Publication No. 2010/032494, Japanese Patent Laid-Open No. 2006-043274, Japanese Patent Laid-Open No. 2011-502699, and Japanese Patent Laid-Open No. 2008-229270). For example, International Publication No. 2010/032494 discloses a system which performs X-ray imaging using one of a CR (Computed Radiography) cassette and an FPD (Flat Panel Detector). In International Publication No. 2010/032494, when executing X-ray Imaging using the CR cassette, start of X-ray irradiation from an X-ray generation unit is permitted as soon as an operator operates an operation button for X-ray irradiation. On the other hand, when executing X-ray imaging using the FPD, start of X-ray irradiation from the X-ray generation unit is not permitted as soon as the operator operates the operation button for X-ray irradiation but is permitted after the FPD is prepared. Furthermore, for example, Japanese Patent Laid-Open No. 2008-229270 describes an X-ray imaging system using two FPDs having different fields of view.

In general, an FPD regularly undergoes initialization processing to improve image quality. Therefore, an X-ray imaging system using an FPD permits X-ray irradiation after the initialization processing is completed. That is, in such X-ray imaging system, if an X-ray irradiation request is generated when the operator operates the operation button during the initialization processing, X-ray irradiation is performed upon completion of the initialization processing, irrespective of elapsed time duration after the start of the initialization processing. A length of time duration until preparation for imaging using the FPD finishes varies depending on the operation time of the operation button for X-ray irradiation, and a length of time duration until X-ray irradiation is actually performed varies depending on the length of the time duration. As described above, in the case of imaging using the FPD, X-ray irradiation is performed when time duration, a length of which is different for each imaging operation, elapses after the operation of the operation button, and thus the operator cannot recognize an imaging time.

To solve this problem, for example, Japanese Patent No. 4810013 describes a technique of performing X-ray imaging when predetermined time duration elapses after accepting a signal to request X-ray irradiation. More specifically, in Japanese Patent No. 4810013, a signal to permit X-ray irradiation is output when a time difference between a signal acceptance time and an initialization start time elapses after initialization processing ends.

In, for example, the method described in International Publication No. 2010/032494, however, a length of time duration from when the X-ray irradiation button is pressed until start of X-ray irradiation is permitted is different depending on whether the CR cassette or the FPD is used. Therefore, the operator cannot perform irradiation at a desired time. Similarly, for example, in the method described in Japanese Patent Laid-Open No. 2008-229270, lengths of the initialization time duration of FPDs having different fields of view are different from each other. If, therefore, start of X-ray irradiation is permitted as soon as initialization ends, a length of time duration from the operation to permission of start of X-ray irradiation varies depending on an FPD to be used and the time of the operation by the operator. Furthermore, in the method described in Japanese Patent No. 4810013, X-ray irradiation permission is issued when the initialization time duration of the FPD elapses after the operation. Therefore, when a plurality of FPDs having different fields of view are used, lengths of time duration from the operation to permission of X-ray irradiation varies depending on an FPD to be used.

As described above, since the conventional methods cannot start X-ray irradiation from the X-ray generation unit when predetermined time duration elapses after the operator operates the operation button for X-ray irradiation, the operator cannot execute X-ray imaging at a desired time. If the operator cannot execute X-ray imaging at a desired time, it may be necessary to re-execute X-ray imaging. As a result, the radiation exposure dose of a subject unwantedly increases.

### SUMMARY OF THE INVENTION

The present invention has been made in consideration of the above problem, and provides a technique of making a length of time duration from an operation to X-ray irradiation constant when executing X-ray imaging using one of a plurality of radiation detection methods. A radiation imaging apparatus according to the present invention which includes a radiation generation unit configured to generate radiation and a plurality of detection units each configured to detect the radiation irradiated from the radiation generation unit, and acquires an image based on the radiation detected by one of the plurality of detection units, the apparatus comprises: an acceptance unit configured to accept a radiation irradiation instruction; and an adjustment unit configured to adjust a time of generating radiation by the radiation generation unit so that a time period from when the irradiation instruction is accepted until radiation irradiation is performed becomes constant, based on time duration, for each of the plurality of detection units, from when the irradiation instruction is accepted until the detection unit enters a radiation detectable state.

Further features of the present invention will become apparent from the following description of exemplary embodiments with reference to the attached drawings.

### BRIEF DESCRIPTION OF THE DRAWINGS

FIG. 1 is a block diagram showing an example of the configuration of a radiation imaging system;

FIG. 2 is a timing chart when performing X-ray imaging using an FPD;

FIG. 3 is a timing chart when performing X-ray imaging using an X-ray film or CR cassette;

FIG. 4 is a block diagram showing an example of the configuration of a radiation imaging system according to the second embodiment; and

FIG. 5 is a timing chart when performing X-ray imaging using an FPD having a narrow field of view.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### (Configuration of Radiation Imaging System)

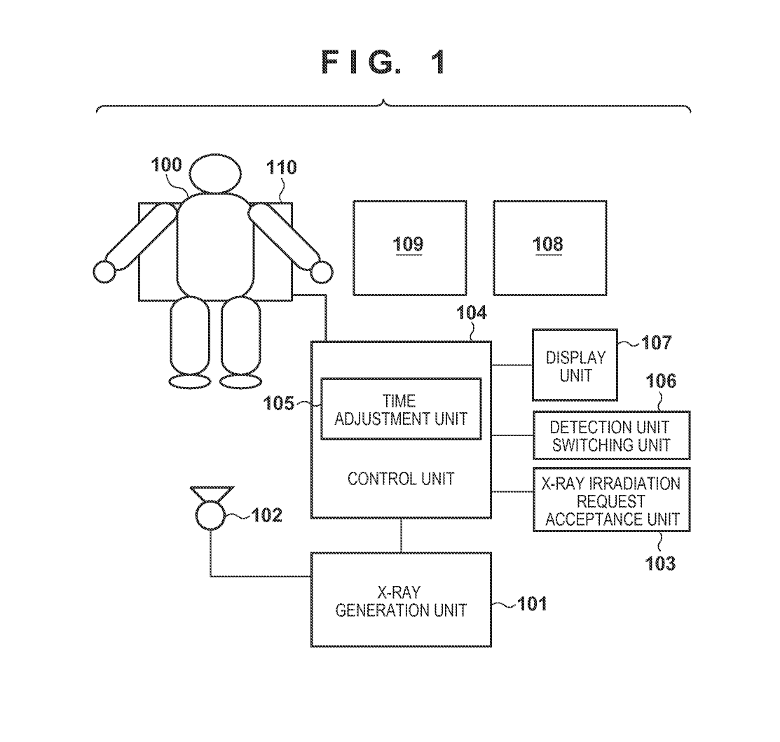

FIG. 1 shows an example of the configuration of radiation imaging system according to the embodiment. The radiation imaging system of this embodiment is formed as an X-ray imaging system using X-rays as radiation. The radiation imaging system may be of a stationary type or portable type. Note that although the radiation imaging system will be exemplified below, it is apparent that the whole radiation imaging system except for a subject can be considered as a single apparatus, and can be formed as one radiation imaging apparatus.

As an example, a case in which the radiation imaging system includes a flat panel detector (FPD), an X-ray film, and a computed radiography (CR) cassette as X-ray detection units will now be described.

The radiation imaging system shown in FIG. 1 includes an X-ray generation unit 101, an X-ray tube 102, an X-ray irradiation request acceptance unit 103, a control unit 104, a detection unit switching unit 106, and a display unit 107, and further includes an X-ray film 108, a CR cassette 109, and an FPD 110 as X-ray detection units. The control unit 104 includes a time adjustment unit 105. By using these functions, the radiation imaging system performs radiation imaging on a subject 100 and outputs a captured image.

Upon accepting an X-ray irradiation permission signal (to be described later) from the control unit 104, the X-ray generation unit 101 generates X-rays from the X-ray tube 102. Note that the X-ray generation unit 101 may be a radiation generation unit for generating radiation from an irradiation unit which irradiates radiation other than X-rays. The X-ray irradiation request acceptance unit 103 accepts an instruction to perform X-ray irradiation. More specifically, the X-ray irradiation request acceptance unit 103 is an operation unit (not shown) for accepting an operation by an operator or a signal reception unit for receiving an operation acceptance signal generated upon accepting an operation by the operation unit. The operation unit is, for example, a two-stage hand or foot switch or a push button switch, or the like. Upon accepting an instruction, the X-ray irradiation request acceptance unit 103 generates an X-ray irradiation request signal, and transmits it to the control unit 104. Note that if there are a plurality of operation units, a plurality of X-ray irradiation request acceptance units 103 may exist.

The control unit 104 is connected to the X-ray generation unit 101 and the X-ray irradiation request acceptance unit 103 by wired or wireless connection, accepts the X-ray irradiation request signal from the X-ray irradiation request acceptance unit 103, performs processing necessary for X-ray irradiation, and then outputs an X-ray irradiation permission signal to the X-ray generation unit 101. Note that a metal line or optical line may be used as a wired connection method. As a wireless connection method, for example, a wireless LAN, infrared light, an ultrasonic wave, or any other methods may be used. Furthermore, wired connection is not necessarily established all the time, and may be established via a detachable connector, as needed. For example, the FPD 110 is connected to the control unit 104 by a detachable connector, and may be detached when not used.

The time adjustment unit 105 adjusts the time of X-ray irradiation based on time duration, for the X-ray detection unit, from when an imaging request is accepted until the X-ray detection unit actually enters an X-ray detectable state. A practical example of the operation of the time adjustment unit 105 will be described later. The display unit 107 displays an X-ray image acquired by imaging.

Each of the X-ray film 108 which is exposed to X-rays, the CR cassette 109 including a photostimulable phosphor sheet, and the FPD 110 including a plurality of detection elements each of which detects X-rays and accumulates charges serves as an X-ray detection unit for detecting the radiation propagated through the subject. These X-ray detection units are switched by the detection unit switching unit 106, thereby selecting an X-ray detection unit to be used for imaging. The detection unit switching unit 106 is, for example, a selection switch, and switches between imaging using the FPD 110 and imaging using a function other than the FPD 110 by detecting that the operator has operated the selection switch. The radiation imaging system acquires a radiation image using one of the X-ray detection units.

### (Operation of Radiation Imaging System)

FIG. 2 is a timing chart when performing X-ray imaging using the FPD 110.

A detection unit switching signal is a signal output from the detection unit switching unit 106. When the signal is at high level, an imaging unit performs imaging using the FPD 110. When the signal is at low level, the imaging unit performs imaging using a function other than the FPD 110. FIG. 2 shows a state in which the detection unit switching signal is at high level for performing imaging using the FPD 110.

The X-ray irradiation request signal is an instruction signal which is generated by the X-ray irradiation request acceptance unit 103 when the operator operates the operation unit (not shown) and which indicates that X-ray irradiation should be performed. When the instruction signal is at high level, X-ray irradiation is requested. When the instruction signal is at low level, X-ray irradiation is not requested. Referring to FIG. 2, for example, the operator operates the operation unit such as an operation button to continuously output an X-ray irradiation instruction from a time T1 to a time T4.

A time adjustment processing state represents the adjustment state of time duration from when the X-ray irradiation request signal is accepted, that is, the X-ray irradiation instruction by the operator is accepted until the X-ray generation unit 101 actually performs X-ray irradiation. When the time adjustment processing state is at high level, the time adjustment unit 105 adjusts the time duration. On the other hand, when the time adjustment processing state is at low level, the time adjustment unit 105 does not adjust the time duration. FIG. 2 shows a state in which the time adjustment processing state is always at low level, and the time adjustment unit 105 does not adjust the time duration.

An FPD initialization processing state represents the initialization processing state of the FPD 110. When the FPD initialization processing state is at high level, the FPD 110 performs initialization processing. On the other hand, when the FPD initialization processing state is at low level, the FPD 110 does not perform initialization processing. Note that when the FPD initialization processing state is set at high level and then set at low level, the FPD 110 enters a radiation detectable state. FIG. 2 shows a case in which the FPD 110 starts the initialization processing at the time T1, and finishes the initialization processing at a time T2. That is, a length of time duration until the FPD 110 enters the radiation detectable state is (T2−T1).

The X-ray irradiation permission signal is a signal used by the control unit 104 to permit the X-ray generation unit 101 to perform X-ray irradiation. When the X-ray irradiation permission signal is at high level, the X-ray generation unit 101 is permitted to perform X-ray irradiation. On the other hand, when the X-ray irradiation permission signal is at low level, the X-ray generation unit 101 is not permitted to perform X-ray irradiation. An X-ray irradiation state represents the X-ray irradiation state of the X-ray generation unit 101. When The X-ray irradiation state is at high level, the X-ray generation unit 101 performs X-ray irradiation. When the X-ray irradiation is at low level, the X-ray generation unit 101 does not perform X-ray irradiation. Referring to FIG. 2, the X-ray irradiation permission signal is at high level from the time T2 to a time T3 and X-ray irradiation is correspondingly performed.

In FIG. 2, as a result of the operator operating the detection unit switching unit 106 to perform imaging using the FPD, the detection unit switching signal is set at high level. In response to the operation of the operation unit by the operator when he/she wants to perform X-ray imaging while looking at the posture, movement, or the like of the subject, the X-ray irradiation request signal is set at high level (time T1).

Upon detecting that the X-ray irradiation request signal is set at high level while the detection unit switching signal is at high level, the control unit 104 instructs the FPD 110 to execute the initialization processing. Upon receiving the instruction of the initialization processing from the control unit 104, the FPD 110 executes the initialization processing, and the FPD initialization processing state is set at high level (time T1). Upon completion of the initialization processing, the FPD 110 notifies the control unit 104 that the initialization has finished, and the FPD initialization processing state is set at low level (time T2). Upon receiving the notification that the initialization processing of the FPD 110 has finished, the control unit 104 sets the X-ray irradiation permission signal at high level, and outputs the X-ray irradiation permission signal to the X-ray generation unit 101 (time T2). Note that when the detection unit switching signal is at high level, the time adjustment unit 105 does not adjust the time duration. Therefore, the time adjustment processing state is always at low level.

When the X-ray irradiation permission signal is set at high level, the X-ray generation unit 101 causes the X-ray tube 102 to perform X-ray irradiation. When predetermined irradiation time duration elapses, the control unit 104 sets the X-ray irradiation permission signal at low level, and instructs the X-ray generation unit 101 to stop X-ray irradiation. When the X-ray irradiation permission signal is set at low level, the X-ray generation unit 101 stops X-ray irradiation (time T3). A length of the X-ray irradiation time duration (T3−T2) varies depending on a portion, for which imaging is performed, or imaging technique, but generally falls within the range from several ten ms to several hundred ms. Furthermore, FIG. 2 shows a case in which the X-ray irradiation request signal is at high level while the X-ray irradiation state is at high level. If, however, the X-ray irradiation request signal is set at low level while the X-ray irradiation is at high level, the X-ray generation unit 101 stops X-ray irradiation even though the predetermined irradiation time duration has not elapsed yet.

When X-ray irradiation stops, the control unit 104 reads out an X-ray image from the FPD 110, performs image processing or the like, and displays the captured X-ray image on the display unit 107. If there is no problem with the displayed X-ray image, the operator saves the captured X-ray image or transfers it to an image server or the like.

As described above, a length of time duration (T2−T1) from when the X-ray irradiation request signal is set at high level until the X-ray irradiation permission signal is set at high level indicates a length of the time duration taken to execute the initialization processing of the FPD 110. Note that a length of this time duration is constant, and is generally about 200 ms or shorter. If, therefore, the FPD 110 is used, the operator can perform X-ray imaging at a desired time by performing an operation of instructing X-ray irradiation at a point in time earlier than the desired time by the length of this time duration.

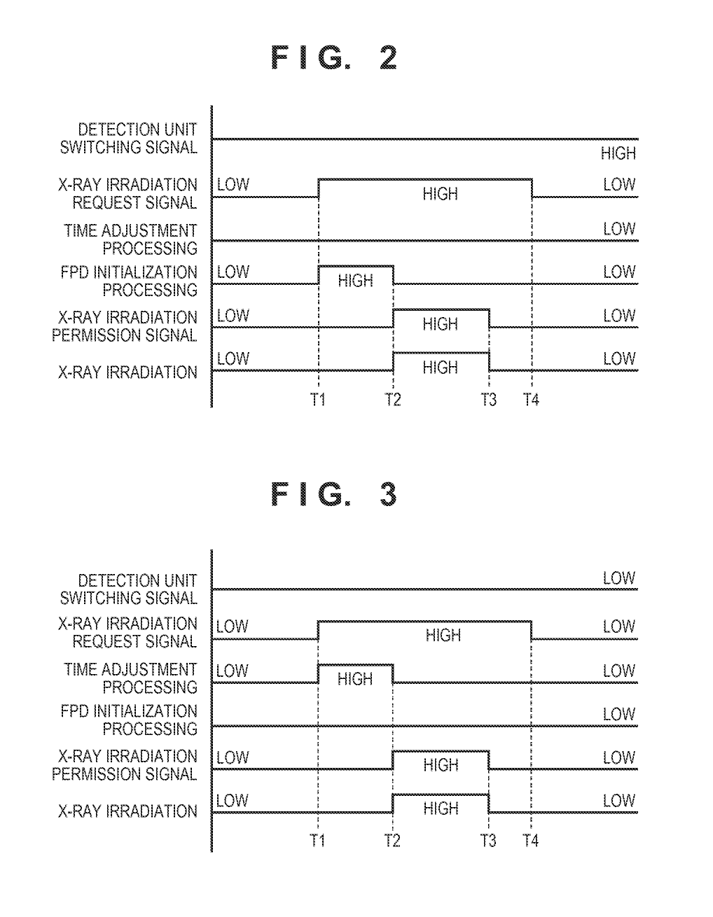

FIG. 3 is a timing chart when performing X-ray imaging using the X-ray film 108 or the CR cassette 109. The meanings of respective signals and respective states shown in FIG. 3 are the same as those shown in FIG. 2 and a description thereof will be omitted.

Referring to FIG. 3, as a result of the operator operating the detection unit switching unit 106 to perform imaging using a function other than the FPD 110, the detection unit switching signal is set at low level. Upon detecting that the X-ray irradiation request signal is set at high level while the detection unit switching signal is at low level, the control unit 104 controls the time adjustment unit 105 to make a time period from when the X-ray irradiation request signal is accepted until X-ray irradiation is performed coincide with that when the FPD 110 is used. More specifically, according to the relationship between FIGS. 2 and 3, in FIG. 3, the time adjustment unit 105 sets a length of wait-time duration (T2−T1) so that a length of the time period from when the X-ray irradiation request signal is accepted until X-ray irradiation is performed is T2−T1, and executes wait processing of adjusting the time when X-ray irradiation is performed. While the time adjustment unit 105 executes the wait processing, the time adjustment processing state is set at high level. After the wait-time duration elapses, the time adjustment unit 105 finishes the wait processing, thereby setting the time adjustment processing state at low level. When the time adjustment unit 105 finishes the wait processing, the control unit 104 sets the X-ray irradiation permission signal at high level, and outputs the X-ray irradiation permission signal to the X-ray generation unit 101 (time T2).

Subsequent processing is the same as that when the FPD 110 is used. If, however, the X-ray film 108 is used to perform imaging, it is possible to acquire a captured X-ray image by developing the X-ray film using an X-ray film developer (not shown). Alternatively, if the CR cassette 109 is used to perform imaging, a CR reading apparatus (not shown) is used to read out an image recorded in the CR cassette 109, and then image processing or the like are executed to display an X-ray image acquired by imaging on the display unit 107. If there is no problem with the displayed X-ray image, the operator saves the captured X-ray image or transfers it to the image server or the like.

With the above operation, the time period from when the X-ray irradiation request signal is accepted until X-ray irradiation is performed when the FPD 110 is used as an X-ray detection unit can be set the same as that when a unit other than the FPD 110 is used as an X-ray detection unit. Therefore, when the operator performs an operation of instructing X-ray irradiation at a point in time earlier than a desired X-ray imaging time by a length of the time duration required for the initialization processing of the FPD 110, it is possible to perform X-ray imaging at the desired time irrespective of an X-ray detection unit to be used. As a result, the radiation exposure dose of the subject can be suppressed. According to the present invention, when performing radiation imaging using one of the plurality of radiation detection methods, it is possible to make a length of the time duration from an operation to X-ray irradiation constant, thereby enabling the operator to execute X-ray imaging at a desired time.

Note that the above description does not consider the time duration taken for communication between the control unit 104 and the X-ray irradiation request acceptance unit 103, FPD 110, and X-ray generation unit 101, or internal processing of the control unit 104. This time duration is often short enough, and the internal processing of the control unit 104 when the FPD 110 is used is not so different from that when the FPD 110 is not used. It is, therefore, possible to ignore the time duration in this processing.

Note that, for example, communication between the control unit 104 and the FPD 110 is not performed when the X-ray film 108 or CR cassette 109 is used. When the FPD 110 is used, therefore, the time adjustment unit 105 may set wait-time duration in consideration of the time duration. If another delay specific to the FPD 110 or a function other than the FPD 110 occurs, the time adjustment unit 105 may set wait-time duration in consideration of the delay. Furthermore, the time adjustment unit 105 may consider time duration from when the X-ray irradiation request signal is set at high level until the FPD initialization processing state is set at high level, the time duration taken for communication between the X-ray irradiation request acceptance unit 103 and the control unit 104, or the time duration taken for the internal processing of the control unit 104 or the like. The time adjustment unit 105 may also consider time duration from when the control unit 104 sets the X-ray irradiation permission signal at low level until the X-ray generation unit 101 actually stops X-ray irradiation.

In the above-described embodiment, when the operator operates the selection switch, the detection unit switching unit 106 switches the imaging unit. The present invention, however, is not limited to this. For example, the detection unit switching unit 106 may be implemented by software, which may display icons respectively representing usable X-ray detection units (FPD 110 and the like) on the display unit 107, and switch the X-ray detection unit to be used by selecting one of the icons. Note that if the display unit 107 is formed by a touch panel, when the operator touches an icon on the display unit 107, a corresponding X-ray detection unit may be selected to be used. Or, an X-ray detection unit to be used may be selected via an interface such as a mouse. Alternatively, the detection unit switching unit 106 may include an arbitrary sensor, and automatically select an X-ray detection unit to be used for imaging in accordance with an environment detection result by the sensor.

Furthermore, in the above-described embodiment, a case in which one FPD, one X-ray film, and one CR cassette are included as X-ray detection units has been explained. However, the present invention is not limited to this. For example, X-ray detection units may include one FPD and a plurality of X-ray films. That is, X-ray detection units may include arbitrary components as long as they can detect X-rays. In this case, the time adjustment unit 105 can set wait-time duration with reference to an X-ray detection unit having longest time duration from when the operator instructs to perform X-ray irradiation until the X-ray detection unit enters the X-ray detectable state. That is, for example, irrespective of an X-ray detection unit to be used, the time adjustment unit 105 sets, as an X-ray irradiation permission time, the time when the time duration from when the operator instructs to perform X-ray irradiation until the X-ray detection unit enters the detectable state elapses. Alternatively, the time adjustment unit 105 sets, as an X-ray irradiation permission time, the time when a time period obtained by adding predetermined time duration to the time duration from when the operator instructs to perform X-ray irradiation until the X-ray detection unit enters the detectable state elapses. By setting, as a reference, an X-ray detection unit having a longest length of time duration until it enters the X-ray detectable state, wait-time duration after the operator instructs to start X-ray irradiation becomes constant for all the X-ray detection units. This enables the operator to perform X-ray imaging at a desired time irrespective of an X-ray detection unit to be used.

### Second Embodiment

In this embodiment, a case in which a radiation imaging system includes one FPD having a narrow field of view and one FPD having a wide field of view as X-ray detection units will be described. In general, a length of the time duration taken to execute initialization processing for the FPD having a narrow field of view is shorter than that for the FPD having a wide field of view. In this embodiment, a method of controlling an X-ray irradiation time in consideration of a difference in lengths of time duration taken for the initialization processing will be explained.

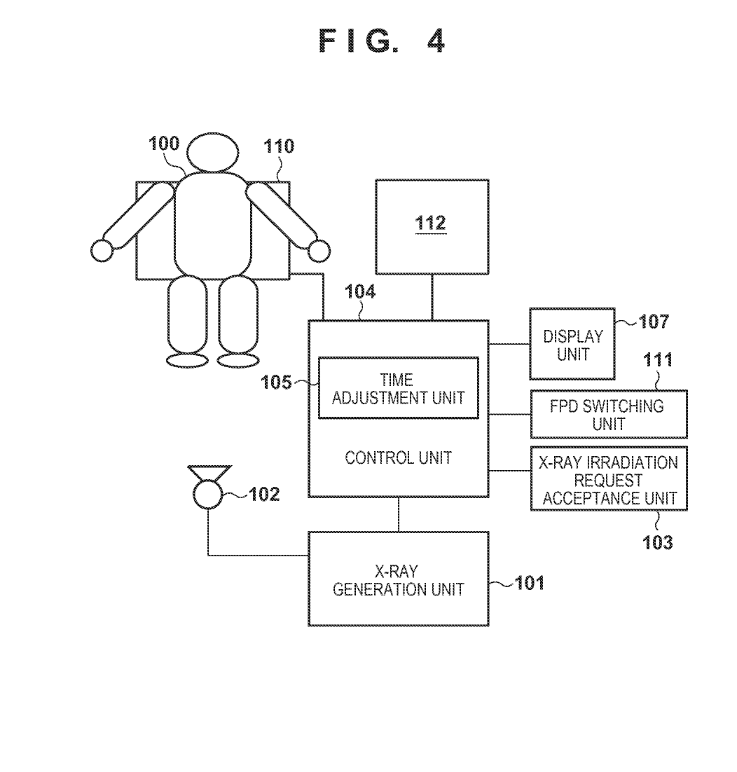

FIG. 4 is a schematic block diagram showing a radiation imaging system according to this embodiment. The radiation imaging system shown in FIG. 4 is different from that shown in FIG. 1 in that it includes one FPD 112 having a narrow field of view and one FPD 110 having a wide field of view as X-ray detection units without including the X-ray film 108 or CR cassette 109. The radiation imaging system shown in FIG. 4 includes an FPD switching unit 111 instead of the detection unit switching unit 106 shown in FIG. 1.

Note that the FPD 110 having a wide field of view is the same as the FPD 110 in the first embodiment. Therefore, a time chart associated with X-ray imaging using the FPD 110 having a wide field of view is the same as that shown in FIG. 2 except that the FPD switching unit 111 outputs an FPD switching signal instead of the detection unit switching signal. When X-ray imaging is performed using the FPD 110 having a wide field of view, the FPD switching signal is at high level. When X-ray imaging is performed using the FPD 112 having a narrow field of view, the FPD switching signal is at low level. Upon detecting that an X-ray irradiation request signal is set at high level while the FPD switching signal is at high level, a control unit 104 instructs the FPD 110 to execute the initialization processing. Subsequent processing is the same as that described with reference to the timing chart shown in FIG. 2 and a description thereof will be omitted.

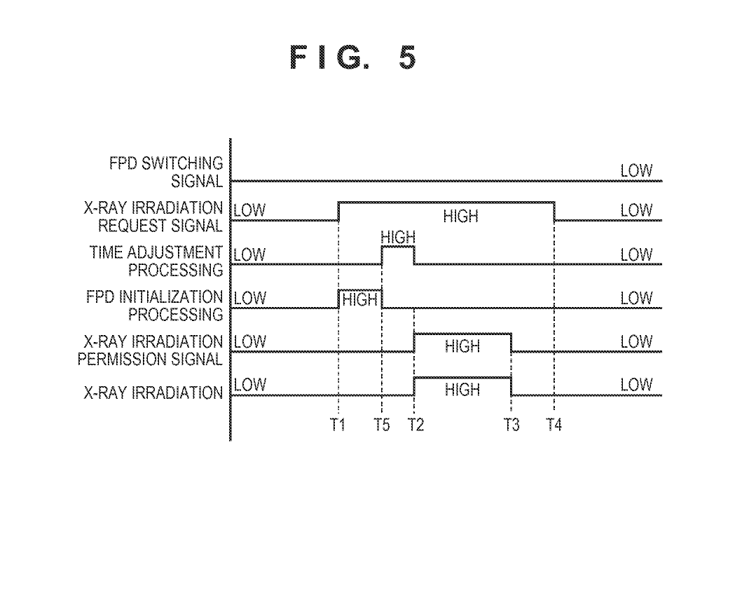

FIG. 5 is a timing chart when performing X-ray imaging using the FPD 112 having a narrow field of view. Upon detecting that the X-ray irradiation request signal is set at high level while the FPD switching signal is at low level, the control unit 104 instructs the FPD 112 to execute the initialization processing. Upon receiving the instruction of the initialization processing from the control unit 104, the FPD 112 executes the initialization processing, and an FPD initialization processing state is set at high level. Upon completion of the initialization processing, the FPD 112 notifies the control unit 104 that the initialization processing has finished, and the FPD initialization processing state is set at low level.

Note that since the FPD 112 has a field of view narrower than that of the FPD 110, a length of its initialization time duration is shorter, and the time when initialization of the FPD finishes is earlier than that in the case of using the FPD 110 (time T5). A time adjustment unit 105 thus executes wait processing to make an X-ray irradiation time coincide with that in the case of using the FPD 110. That is, since a length of the time duration taken to execute the initialization processing is (T2−T1) in the case of using the FPD 110, and is (T5−T1) in the case of using the FPD 112, wait-time duration is set such that a length of the wait-time duration becomes (T2−T1)−(T5−T1)=T2−T5. After the time adjustment unit 105 performs time adjustment by the wait-time duration whose length is (T2−T5), the control unit 104 outputs an X-ray irradiation permission signal to an X-ray generation unit 101 (time T2). A subsequent operation is the same as that explained with reference to the timing chart shown in FIG. 2 and a description thereof will be omitted. Note that a time of performing the time adjustment may be after the initialization processing, as described above, or time adjustment may be performed before the initialization processing and the FPD 112 may start initialization after wait-time duration elapses.

To perform time adjustment, the time adjustment unit 105 needs to know a length of the initialization time duration of the FPD 110 having a wide field of view and that of the FPD 112 having a narrow field of view. Therefore, the time adjustment unit 105 may, for example, store the length of the initialization time duration of the FPD 110 having a wide field of view and that of the FPD 112 having a narrow field of view in advance, and read out the stored length of the initialization time duration when the FPD switching unit 111 selects an FPD to be used for imaging. Alternatively, for example, each FPD may store a length of its initialization time duration in a nonvolatile memory. Then, upon start of the radiation imaging system, the control unit 104 may inquire of each FPD about the length of the time duration taken for initialization, and notify the time adjustment unit 105 of the result.

With the above-described processing, even if a plurality of FPDs having different lengths of initialization time duration are included, when the time adjustment unit 105 executes wait processing, it is possible to set the same time when the control unit 104 outputs the X-ray irradiation permission signal to the X-ray generation unit 101 irrespective of an FPD to be used. This makes it possible to always perform X-ray irradiation at the same time irrespective of the width of the field of view of the FPD.

Note that in the above embodiment, the radiation imaging system including the FPD 110 having a wide field of view and the FPD 112 having a narrow field of view has been explained. Other combinations of FPDs can also be used. For example, an X-ray detection unit using amorphous silicon and that using polysilicon or a charge coupled device (CCD) may be used as X-ray detection units. The present invention is also applicable to a case in which the combination of an FPD for general imaging and an FPD for fluoroscopic imaging generally having a short initialization time duration is used as X-ray detection units. Furthermore, the present invention is applicable to a case in which FPDs have different pixel sizes even though they have the same field of view, that is, a case in which an FPD having a small pixel size and a large number of pixels and an FPD having a large pixel size and a small number of pixels are used. The present invention is applicable to a case in which when an X-ray tube 102 includes an X-ray collimator (not shown) and the X-ray collimator narrows the field of view to be used for X-ray imaging, the initialization processing of the FPD is performed for a portion where the field of view is narrowed. In this case, the initialization processing time duration of the FPD varies depending on the field of view narrowed by the X-ray collimator, and the time adjustment unit 105 can perform time adjustment according to the variation of a length of the initialization processing time duration.

Alternatively, for example, one FPD having a narrow field of view, one FPD having an intermediate field of view, and one FPD having a wide field of view may be adopted as X-ray detection units. In combination with the first embodiment, a plurality of FPDs having different fields of view, an X-ray film, and a CP cassette may be included as X-ray detection units, and one of them may be used. Note that in these cases, in order for the time adjustment unit 105 to recognize an X-ray detection unit in use, a detection unit switching signal may be represented as a multilevel signal instead of a binary signal having only high level and low level. For example, the detection unit switching signal may be represented by two or more bits. This makes it possible to make the time duration from when the operator instructs to perform X-ray irradiation until X-ray irradiation is actually performed constant even though any one of the plurality of X-ray detection units of the radiation imaging system is used. It is, therefore, possible to perform X-ray imaging at a time desired by the operator.

### (Other Embodiments)

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-033868 filed on Feb. 22, 2013, which is hereby incorporated by reference herein in its entirety.

What is claimed is:

1. A radiation imaging apparatus which includes a radiation generation unit configured to generate radiation and a plurality of detection units each configured to detect the radiation irradiated from said radiation generation unit, and acquires an image based on the radiation detected by one of said plurality of detection units, the apparatus comprising:
an acceptance unit configured to accept a radiation irradiation instruction; and
an adjustment unit configured to adjust a time of generating radiation by said radiation generation unit so that a length of a time period from when the irradiation instruction is accepted until radiation irradiation is performed becomes constant, based on time duration, for each of said plurality of detection units, from when the irradiation instruction is accepted until said detection unit enters a radiation detectable state.

2. The apparatus according to claim 1, wherein said adjustment unit adjusts the time based on the time duration for said detection unit for which a length of the time duration is longest among said plurality of detection units.

3. The apparatus according to claim 2, wherein said adjustment unit adjusts the time so that the time duration for said detection unit for which the length of the time duration is longest coincides with the time period.

4. The apparatus according to claim 1, wherein
said plurality of detection units include a flat panel detector with a plurality of detection elements each of which detects radiation and accumulates charges.

5. The apparatus according to claim 4, wherein
said plurality of detection units further include another flat panel detector having the time duration different from that of said flat panel detector.

6. The apparatus according to claim 4, wherein
said plurality of detection units further include an X-ray film to be exposed to radiation.

7. The apparatus according to claim 4, wherein
said plurality of detection units further include a computed radiography cassette having a photostimulable phosphor sheet.

8. The apparatus according to claim 1, further comprising
a communication unit configured to communicate with at least one of said plurality of detection units,
wherein said adjustment unit adjusts the time based further on time duration taken for the communication.

9. A radiation imaging apparatus which includes a radiation generation unit configured to generate radiation in response to acceptance of permission and a plurality of detection units each configured to detect the radiation irradiated from said radiation generation unit, and acquires an image based on the radiation detected by one of said plurality of detection units, the apparatus comprising:
an acceptance unit configured to accept an instruction to perform radiation irradiation; and
an adjustment unit configured to adjust a time of outputting the permission to said radiation generation unit so that a length of a time period from when the instruction is accepted until radiation irradiation is performed becomes constant, based on time duration, for each of said plurality of detection units, from when the instruction is accepted until said detection unit enters a radiation detectable state.

10. A control method for a radiation imaging apparatus which includes a radiation generation unit configured to generate radiation and a plurality of detection units each configured to detect the radiation irradiated from the radiation generation unit, and acquires an image based on the radiation detected by one of the plurality of detection units, the method comprising:
accepting a radiation irradiation instruction; and
adjusting a time of generating radiation by the radiation generation unit so that a length of a time period from when the irradiation instruction is accepted until radiation irradiation is performed becomes constant, based on time duration, for each of said plurality of detection units, from when the irradiation instruction is accepted until the detection unit enters a radiation detectable state.

11. A non-transitory computer-readable storage medium storing a computer program for causing a computer, included in a radiation imaging apparatus which includes a radiation generation unit configured to generate radiation and a plurality of detection units each configured to detect the radiation irradiated from the radiation generation unit, and acquires an image based on the radiation detected by one of the plurality of detection units, to execute
accepting a radiation irradiation instruction, and
adjusting a time of generating radiation by the radiation generation unit so that a length of a time period from when the irradiation instruction is accepted until radiation irradiation is performed becomes constant, based on time duration, for each of said plurality of detection units, from when the irradiation instruction is accepted until the detection unit enters a radiation detectable state.
